(19) United States
(12) Patent Application Publication
(10) Pub. No.: US 2025/0182304 A1
(43) Pub. Date: Jun. 5, 2025

(54) AUTOMATIC TRACKING METHOD FOR CO-REGISTRATION OF 2D SEM IMAGES AND 3D TOMOGRAPHIC DATA OF ROCK CYLINDERS

(71) Applicants: PETRÓLEO BRASILEIRO S.A. - PETROBRAS, Rio de Janeiro (BR); UNIVERSIDADE DE SÃO PAULO - USP, São Paulo (BR)

(72) Inventors: DELANO MENECUCCI IBANEZ, Rio de Janeiro (BR); Thais Bortotti Fagundes, Santos (BR); Nicholas Machado Lima, Rio de Janeiro (BR); Cleyton De Carvalho Carneiro, Santos (BR); Rodrigo Surmas, Rio de Janeiro (BR); Yaro Moises Parizek Silva, Rio de Janeiro (BR); Carina Ulsen, São Paulo (BR); Gabriel Do Nascimento Freitas, Rio de Janeiro (BR); Jean Vicente Ferrari, São Paulo (BR); Rodrigo César Teixeira de Gouvêa, Santos (BR); Jhonatan Jair Arismendi Florez, Saõ Paulo (BR)

(73) Assignees: PETRÓLEO BRASILEIRO S.A. - PETROBRAS, Rio de Janeiro (BR); UNIVERSIDADE DE SÃO PAULO - USP, São Paulo (BR)

(21) Appl. No.: 18/969,051

(22) Filed: Dec. 4, 2024

(30) Foreign Application Priority Data
Dec. 5, 2023 (BR) 10202302554845

(51) Int. Cl. G06T 7/30; G06T 3/40; G06T 5/20; G06T 7/13; G06T 7/40

(52) U.S. Cl. CPC G06T 7/30; G06T 3/40; G06T 5/20; G06T 7/13; G06T 7/40; G06T 2207/10061; G06T 2207/10081

(57) ABSTRACT

The present invention comprises a computer-implemented method for automating the co-registration of SEM and 3D microtomography images in rock sample cylinders, characterized by comprising three main steps: (i) image pre-processing; (ii) internal orthogonal search; (iii) external multi-angle search. The method plays a fundamental role in the creation of image pairs. These pairs capture the same region of the rock, but with different analytical properties. Thus, the co-registration between 2D microscopy and 3D tomographic data provides a fundamental basis for the application of machine learning techniques and the expansion of the originally planar mineralogy to the entire three-dimensional volume. The three-dimensional mineralogical model generated from this co-registration has fundamental implications for the creation of digital rock models. The automation of the co-registration process between these acquisitions contributes to the advancement of petroleum engineering, since co-registration accelerates the process of generating image pairs for the use of machine learning algorithms in the generation of the three-dimensional mineralogical model. This method, in its turn, has direct application both in oil reservoir engineering and in geological interpretation.

### CROSS-REFERENCE FOR RELATED APPLICATIONS

This application claims priority to Brazilian Application No. BR 1020230254845, filed on Dec. 5, 2023, the disclosure of which is herein incorporated by reference in the entirety.

### FIELD OF THE INVENTION

The present invention is part of the field of image analysis of rock samples, specifically in three-dimensional reconstruction techniques, more specifically in techniques involving computational image processing of minerals and their visual representation.

### BACKGROUND OF THE INVENTION

In the oil industry, it is common practice during drilling to obtain core samples, extracted along the well, and side samples, extracted from the walls of the well. The cores are taken to laboratories for the development of analyses and selection of strategic or representative zones. From these zones, sample plugs are extracted, that is, cylinders of rock originating from the core sample. Cores, plugs and side samples, therefore, consist of rock cylinders that can vary in diameter.

Traditionally, mineral characterization is done in two dimensions. By viewing the results in three dimensions, a more complete digital representation is revealed, showing shape, size and associations between minerals. This information for the oil industry is important not only to show the presence and quantity of a mineral, but also how the mineral was formed and how it can influence the quality of the reservoir. The influence of composition, characteristics, genesis and mineral content on the quality of the reservoir is a key problem that needs to be studied in depth. Since 3D digital images can show the detailed characteristics of rocks, three-dimensional data helps to understand, for example, the formation of diagenetic minerals that is closely related to chemical and mineralogical changes in sediments and the formation and destruction of pore spaces, making them important factors that affect the physical properties of rocks and types of reservoirs.

Among several techniques involved in the process of rock characterization and widely used in the oil industry are X-ray tomography (and microtomography) systems (MCT) and optical microscopy and Scanning Electron Microscopy (SEM) systems. 3D X-ray tomography is a non-destructive characterization technique that, by rotating an object on a fixed axis, allows the production of 3D images of the internal structure of a material. Scanning Electron Microscopy (SEM) associated with chemical microanalysis systems (EDS/EDX) is used to characterize the surface of samples, as well as their chemical, topographic and crystallographic composition, by analyzing the interaction of electrons from the study surface with a thin electron beam irradiated on the sample.

Cores, side samples and plugs are cylinders of rocks obtained from well drilling activities that are essential for a detailed analysis of the mineralogical composition and petrophysical properties of reservoir rocks. The characterization of the geometric framework of minerals and pores of these cylinders is performed using the acquisition of 3D tomographic data. Mineralogical characterization is commonly performed by microscopy, including SEM analyses of sections of the cylinder.

The use of microscopy image co-registrations in conjunction with 3D tomographic data can play a fundamental role in the creation of image pairs. These pairs capture the same region of the rock, but with different analytical properties. Thus, the co-registration between 2D microscopy and 3D tomographic data provides a fundamental basis for the application of machine learning techniques and the expansion of the originally planar mineralogy to the entire three-dimensional volume. This co-registration is traditionally done visually and with the supervision of a specialist for applications involving the pairing of these two techniques.

The three-dimensional mineralogical model generated from this co-registration has fundamental implications for the creation of digital rock models, widely used in the oil industry. These pairs of images capture the same region of the rock, but with different acquisition properties, a volume and a section segmented by interpretation, in a SEM-AI system (SEM image analysis, providing a fundamental basis for the application of machine learning techniques in predicting the mineralogy of samples from tomography data).

The automation of the co-registration process between these acquisitions contributes to the advancement of petroleum engineering. This occurs due to the fact that co-registration accelerates the process of generating image pairs for the use of machine learning algorithms in generating the three-dimensional mineralogical model. This model, in its turn, has direct application both in petroleum reservoir engineering and in geological interpretation. The automated co-registration process facilitates the generation of flow models in porous media with known mineralogy, in addition to providing inputs for improving the calculation of wettability, flow and permeability simulations, among others.

In short, the technical problem in question is based on the difficulty of pairing data obtained by tomography with data obtained by SEM in order to capture different analytical and imaging properties to more adequately characterize the rock under analysis, mainly through machine learning and expansion of the originally planar mineralogy to a three-dimensional mineralogical model.

### STATE OF THE ART

The search for the history of the invention in question resulted in the verification of some relevant documents from the state of the art, which still have unresolved differences and technical deficiencies.

Reyes et al. (2017) contextualize that X-ray microtomography (XMT) has the potential to extend measurement capabilities for the three-dimensional (3D) evaluation of properties such as mineral release, grain size and textural characteristics, while SEM, when coupled with energy-dispersive X-ray spectroscopy (EDX), provides elemental compositions and, therefore, a more direct method for distinguishing different minerals. Thus, the authors showed a methodology that combines these two methods at the mineral grain level.

The rock particles used to test the method were initially visualized in 3D using XMT, followed by sectioning and 2D imaging of the portions using SEM-EDX. An algorithm was developed that allowed the mineral grains in the 2D portion to be matched to their 3D equivalents in the XMT-based images.

It should be noted first that the spatial resolution (pixel size) of the tomography used in the aforementioned article is 9 to 16 micrometers due to the small size of the sample used, which allows for greater proximity in style with the acquisition of images from the SEM, as well as a better definition of mineral contact and a lower attenuation of the values recorded in the microtomography due to the presence of the mineralogical assembly in a rock cylinder.

In other words, the methodology of the aforementioned article becomes specific to individual grains, without a proven application in the wide variety of measurement ranges on the microscopic scale, with the presence of multiple grains that form different textures, commonly used by the oil industry in cylinder analyses in the form of plugs, side samples and cores.

In addition, the gangue matrix and the bright phase (ore minerals) are segmented from the air and pores by the Otsu algorithm, and this automation for creating a binary image with the threshold meaning background/pore and minerals only works for a histogram distribution that is bimodal, that is, it is specific for acquisitions with low mineralogical and textural complexity and with large attenuation differences, as in the case showed between silicates and sulfides, and would not be applicable in the case of sedimentary oil reservoirs.

Still based on the aforementioned article, Reyes et al. (2017) disclose that the comparisons for the co-registration of the two acquisitions are made from segmented images, using the interpreted image of the SEM-MLA for the mineralogy of the analyzed fragment and the segmented image of the microtomography, using the global thresholding algorithm of the maximum entropy of each fragment, and this binary mask of the microtomography is then manually labeled using a connectivity algorithm, with a neighborhood of 8 connections, to identify individual grains.

The application of an automated histogram segmentation algorithm can work as long as there is not a large overlap of intensities between the minerals, which does not occur in samples with more complex mineralogy and textures. In other words, if applicable to the present invention, the method of the aforementioned article would require a manual process of labeling these minerals with the connectivity algorithm that would be unfeasible for a very large variation of samples.

Finally, the segmentation comparison algorithm from the histogram (MLA/mct with segmentation by global maximum entropy thresholding) is strongly dependent on the quality of this segmentation, that is, on the multimodality of the histogram. This makes it limited in applications at other scales and in situations where mineralogical segmentation is more complex, limited to mineralogical compositions with minerals of different attenuations, which does not occur in sedimentary oil reservoirs.

In contrast, the method of the present invention takes into account points of interest throughout the images, found automatically, without the need for prior segmentation. The comparison is made of the surroundings of these points (patches that are described in the form of BRIEF binary vectors), becoming independent of a histogram segmentation and allowing variations in the positioning of the contacts between the grains, since it makes punctual comparisons to find the best co-registration.

Another differentiating point is that the evaluation of the neighborhood of the points allows a much greater transfer of the semantics of the compared images, allowing the evaluation of multiple mineral grains. This fundamentally differentiates the two methods, with the method of the aforementioned article being based on a histogram, and that of this proposal based on image semantics.

US 20120281883 describes methods for constructing and/or improving 3D digital models of porous media by combining high and low resolution data to capture large and small pores in single models. High resolution data include laser scanning fluorescence microscopy (LSFM), nanocomputed tomography (CT) scans, and focused ion beam scanning electron microscopy (FIB-SEM). Low resolution data include conventional CT scans, microcomputed tomography scans, and synchrotron computed tomography scans.

US 20120281883 describes a combination of high resolution 2D or 3D LSFM images, acquired for OERs or REVs in rocks, with (b) CT scans, which capture relatively larger 3D volumes at lower resolution. LSFM scans are used as training images for 2D or 3D multipoint statistics to distribute high resolution micropores in low resolution CT volumes, which are used as ground truth to condition the simulations.

In the aforementioned US patent document, co-registration is performed after segmentation of the pores, making its application unfeasible in rocks with few pores or with pores in complex textures, since there is no direct correspondence between microtomography and SEM in relation to the edges of minerals or pore surfaces. On the other hand, this was the motivation for choosing a method based on image semantics, with the use of keypoints, for the object of this proposal.

In addition, the use of multipoint statistics is performed in the simulation of porosity using low and high resolution data, but not during the image co-registration process. Therefore, the development shown in US 20120281883 does not establish the proposed correlation of a point-based method for co-registration.

Therefore, the co-registration of microtomographic images from segmentation and binarization of US 20120281883 fails to solve issues related to high mineralogical and textural complexity. This occurs especially when the process is carried out based on porosity, making co-registration dependent on the presence of pores with sufficiently diverse quantity and distribution.

US 20210231589 discloses an imaging system that includes: a micro-computed tomography (micro-CT) subsystem, a sample processing subsystem. The micro-CT subsystem includes an X-ray source and an X-ray detector and is configured to acquire a three-dimensional image of a specimen. The sample processing subsystem includes a focused ion beam subsystem and a mechanical cutting device. The focused ion beam subsystem is configured to process the specimen in a first processing manner and the mechanical cutting device is configured to process the specimen in a second processing manner to obtain a target section of a target area. The SEM is located above the specimen and is configured to acquire a two-dimensional image of the target section. The processor is configured to perform three-dimensional reconstruction on the two-dimensional images to obtain a three-dimensional image of the specimen.

It should be noted that the document US 20210231589 does not provide details regarding the size of the samples or their respective nature, since the core of the invention is related to reconstruction from the simultaneous acquisition of different sensors, and if there were no displacement of the sample for the acquisitions and the need to find the overlapping region, the co-registration of images would become unnecessary.

In other words, the aforementioned North American patent document makes a simultaneous acquisition of different methods, which differs from a co-registration between images acquired at different times, common to samples used in the oil industry. In addition, the lack of details about the size and nature of the samples analyzed, as well as the absence of information about their experimental feasibility, does not establish a basis for comparing the methods.

US 20180082444 discloses methods of investigating a sample using tomographic images that include the following steps: a sample is provided in a sample holder and a radiation beam is directed through the sample and onto a detector, thereby generating an image of the sample; the directing is repeated for a set of different sample orientations relative to the beam, thereby generating a corresponding set of images; an iterative mathematical reconstruction technique is used to convert the set of images into a tomogram of at least a portion of the specimen; the reconstruction is mathematically constrained so as to reduce a resulting solution space; in addition, three-dimensional SEM images of at least a portion of the specimen that at least partially overlap the portion are obtained; the three-dimensional SEM images are used to perform the constraint step, requiring that the iterative reconstruction results be consistent with the pixel values derived from the images.

With regard to the mathematical reconstruction technique used in said document to produce a tomogram from a series of input images, algorithms such as SIRT (Simultaneous Iterative Reconstruction Technique), ART (Algebraic Reconstruction Technique), DART (Discrete ART), SART (Simultaneous ART), MGIR (Multi-Grid Iterative Reconstruction) and many others can be used.

The focus of the document US20180082444 is related to the restriction of the space of possible values for tomographic reconstruction, using SEM or TEM acquisitions and some mathematical reconstruction techniques comprising: obtaining three-dimensional SEM images of at least a part of the specimen that partially overlaps this portion and using the SEM images to perform the restriction step, requiring that the iterative reconstruction results be consistent with the pixel values derived from the SEM images.

The aforementioned document US 20180082444 does not make it clear whether the acquisitions are made on the same device, whether there is simultaneous acquisition and, if they are not made simultaneously, there is no description of the co-registration process. If the acquisition with overlap is made locally and without modifying the orientation of the sample, there is no basis for comparing the techniques in relation to the present invention, since there is no co-registration being performed.

In short, all the prior art documents analyzed lack details on the image co-registration process, making direct comparison with the proposed method impractical. While the approach suggested in the method of the present invention uses keypoints and the semantics of the images for co-registration, the aforementioned documents focus on statistics, segmentations and reconstruction from different sensors. In short, a person skilled in the art, in possession of the above documents considered in isolation or in combination, could not solve the same technical problem of the present invention in an obvious manner, at least because they could not foresee the consideration of automated points of interest that are based on the internal semantics of the images, and because they did not foresee the direct comparison of images, in an obvious or evident manner.

Thus, the proposed method aimed to overcome these limitations by providing a more versatile, robust and innovative method for image co-registration in mineral and rock analyses. By adopting an automated approach based on keypoints and internal semantics of the images, the method being proposed offers a more accurate and efficient solution for co-registration, enabling a broad and reliable application in several scenarios and types of samples, with mineralogical diversity.

### BRIEF DESCRIPTION OF THE INVENTION

The present invention comprises a computer-implemented method for automating the co-registration of SEM and 3D microtomography images in rock sample cylinders, characterized by comprising three main steps: (i) image pre-processing; (ii) internal orthogonal search; (iii) external multi-angle search. The method plays a fundamental role in the creation of image pairs. These pairs capture the same region of the rock, but with different analytical properties. Thus, the co-registration between 2D microscopy and 3D tomographic data provides a fundamental basis for the application of machine learning techniques and expansion of the originally planar mineralogy to the entire three-dimensional volume. The three-dimensional mineralogical model generated from this co-registration has fundamental implications for the creation of digital rock models. The automation of the co-registration process between these acquisitions contributes to the advancement of petroleum engineering, as co-registration accelerates the process of generating image pairs for the use of machine learning algorithms in the generation of the three-dimensional mineralogical model. This method, in its turn, has direct application both in petroleum reservoir engineering and in geological interpretation. The automated co-registration process facilitates the generation of flow models in porous media with known mineralogy, in addition to providing inputs for improving the calculation of wettability, flow and permeability simulations, among others.

### BRIEF DESCRIPTION OF THE FIGURES

FIG. 1 represents a flowchart of the method of the present invention.

FIG. 2 represents the flowchart of the method of the present invention with detailed parameters.

FIG. 3 shows an example of the Correspondence Graph, in which the values represent: Current Cut: updated at each iteration; Best Cut: cut with the highest number of correspondences (matches); Correspondences: number of correspondences of the best cut.

FIG. 4 shows a schematic drawing of how the internal multi-angle search works.

FIG. 5 shows a schematic drawing of how the external multi-angle search works.

FIG. 6 shows an example of the result of the co-registration between MEV and MCT.

FIG. 7 shows four samples that were subjected to the MEV-MCT co-registration process.

FIG. 8 shows the correspondence points of the co-registered samples.

FIG. 9 shows the co-registration of Sample F9796H with the comparison between the co-registered mCT and BSE images of the SEM.

FIG. 10 shows the best correspondence graphs for the internal orthogonal search (above), external multiazimuthal gross search (middle) and external multiazimuthal fine-tuning search (below).

FIG. 11 shows the comparisons of the co-registration resulting from the automated search process for 3 analyzed samples: G0397H, F9848H and F9895H.

### DETAILED DESCRIPTION OF THE INVENTION

The present invention provides means for a series of techniques to be chained and adjusted to process and co-register 2D scanning electron microscopy (SEM) and 3D microtomography images of rock cylinders.

The present invention uses the keypoint comparison technique, preferably detected at the edges of the objects in the image, taking into account the orthogonal positioning to the main axis of the cylinder and its angular variations. The images undergo initial pre-processing and are then subjected to a flow of detection, description and comparison of keypoints. The pairs of keypoints selected during the comparison process are filtered to obtain the best co-registration.

Initially, a search called internal orthogonal is performed to locate the best position along the main axis of the cylinder and then moves on to a search called external multi-angle to find the best co-registration in non-orthogonal sections of the microtomographic volume.

The present invention, therefore, comprises a computer-implemented method for automating the co-registration of SEM and 3D microtomography images in rock sample cylinders characterized by comprising three main steps:
(i) image pre-processing;
(ii) internal orthogonal search;
(iii) external multi-angle search.

The automation of the co-registration between such acquisitions accelerates the generation of image pairs for the application of machine learning algorithms in the development of the three-dimensional mineralogical model. The automation process consists of a fundamental procedure for the construction of the so-called digital rock, an emerging concept in industry 4.0 applications in the area of petroleum engineering. This model, therefore, serves as a basis for several applications, namely: geological interpretation, creation of flow models, characterization of wettability considering known mineralogy, permeability simulations, among other possibilities.

In step (i) co-registration is performed in comparisons between the two-dimensional SEM image and sequential sections of the microtomographic volume.

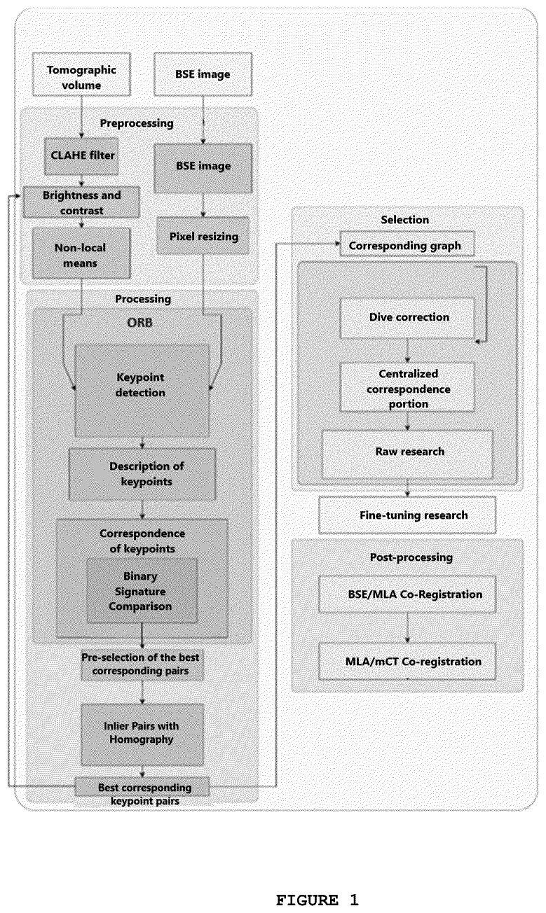

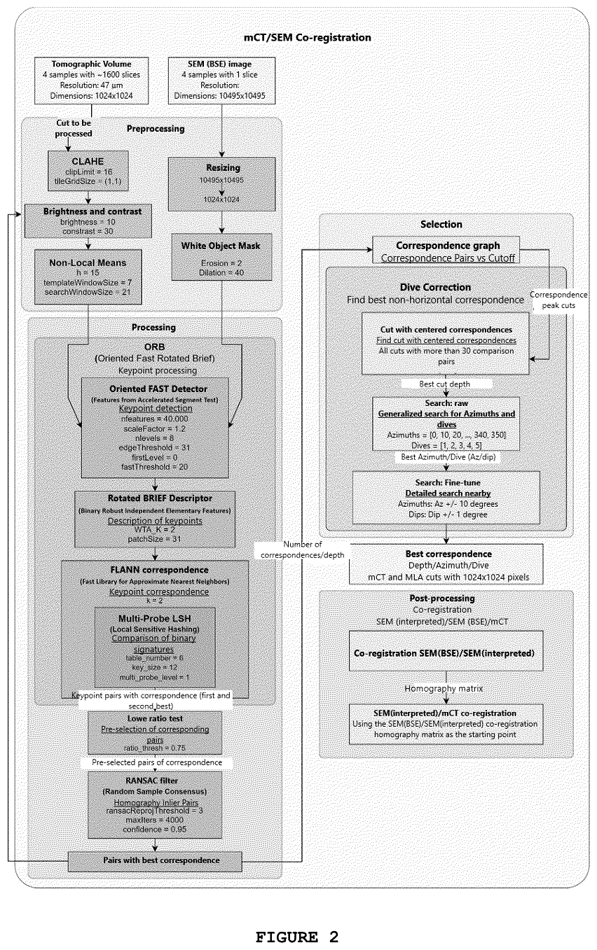

According to FIG. 1, it can be seen that the two-dimensional microtomography images undergo image and histogram balance filters in the pre-processing stage, namely, preferably: Contrast Limited Adaptive Threshold (CLAHE), Brightness, Contrast and Non Local Means.

The application of filters aims to approximate the style and highlight the edges, with the objective of increasing the capacity to detect keypoints. The SEM image, on the other hand, undergoes a reduction in spatial resolution for a better approximation in relation to the dimensions of the microtomographic image.

Furthermore, the phenomena of transmission and absorption of X-rays during tomographic acquisition are sensitive to several factors, such as the specific gravity of the minerals, also known as relative density. In carbonate samples with contrasting mineralogical densities, minerals such as barite (specific gravity of 4.50 g/cm³) and pyrite (specific gravity of 4.80 to 5.00 g/cm³) have low transmittance compared to minerals such as calcite (specific gravity of 2.71 g/cm³) and dolomite (specific gravity of 2.84 to 2.86 g/cm³).

In this context, given the contrast between relative densities, minerals such as barite and pyrite are considered low transmittance minerals compared to the main mineralogical assembly composed of calcite and dolomite. In tomographic images, depending on the grain size of low transmittance minerals, the relative density contrast generates artifacts that obscure neighboring minerals. In SEM images, low transmittance minerals are characterized in histograms by gray level intensities ranging from 100 to 255 (8-bit intensity resolution), while pores and other minerals present gray level intensities between 0 and 100 (8-bit intensity resolution).

A mask for low transmittance minerals can be used in the SEM image to avoid the concentration of keypoints mainly in these minerals. This occurs because low transmittance minerals usually have poorly demarcated contours in the microtomographic volumes due to the generation of acquisition artifacts. The mask applied to these minerals in the SEM images, therefore, avoids the use of the search for keypoints coinciding with the artifact regions.

Once pre-processed, the images are then used as input for processing with the Oriented Fast and Rotated Brief (ORB) algorithm. Key point detection is performed for both images using the Oriented Features from Accelerated Segment Test (oFAST) method of the ORB. The binary descriptor vectors of these keypoints are generated with the rotated Binary Robust Independent Elementary Features (rBRIEF) method.

Sequentially, these vectors from the SEM and tomographic images are compared using the Fast Library for Approximate Nearest Neighbors (FLANN) matcher method. This method performs nearest neighbor searches in a large number of comparison pairs, where traditional exhaustive search methods become computationally expensive.

The FLANN method uses the concept of Local Sensitive Hashing (LSH), a probabilistic hashing technique that maps similar items to the same or nearby hash bins, resulting in a search for the two nearest neighbors of each keypoint of the search image in the training image (k=2).

The good correlations between keypoints found are then filtered using the Lowe Ratio Test (Lowe, 2004), eliminating correspondences with low descriptive power. Good correlations are then tested using the Random Sample Consensus (RANSAC) algorithm for image homography, where the pairs of keypoints considered inliers to the homography are determined. Thus, the image among those that make up the micro-CT volume (3D) that has the highest number of corresponding keypoints, compared pairwise with the SEM image (2D), is established as the one with the best or most accurate correspondence. The confidence level established for the RANSAC algorithm was 95%. These pairs of images with the best correspondence are, therefore, considered the best for developing the homography between the images.

Thus, these pairs with the best correspondences are used to calculate the transformation matrix of the SEM image perspective for co-registration on the microtomographic cutout.

Based on the forensic visual computing method for tattoo identification exemplified in (Howse & Minichino, 2020), the number of inliers after the RANSAC filter is considered to be a strong indication of the existence of the best correspondence between all pairs of compared images. From now on, the number of inliers to the co-registration will be called correspondences. In other words, the best correspondence is comparative, the one that has the largest number of corresponding points in the pairs of compared images has the best correspondence.

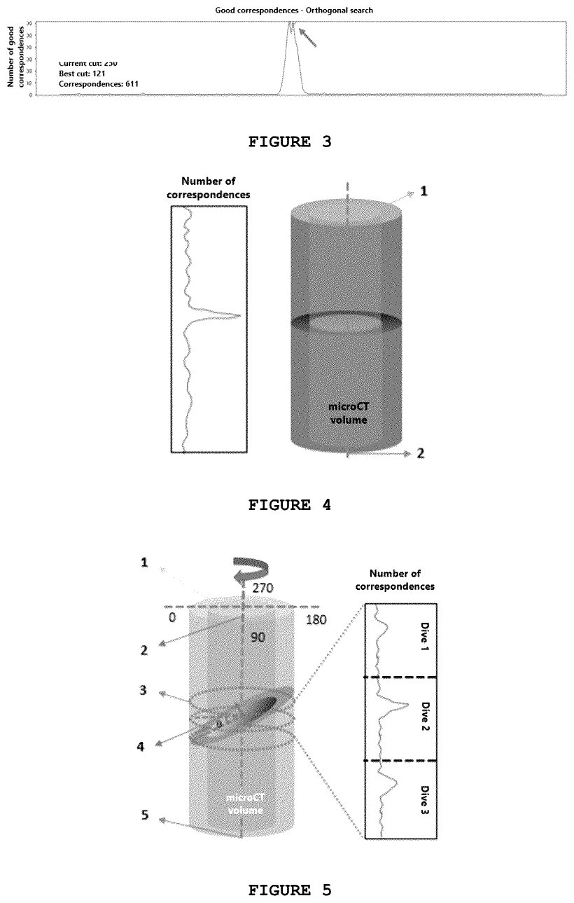

For better visualization, a graph was used with the training images (microtomography) on the abscissa axis and the points recorded after the application of RANSAC on the ordinate axis. This graph, called “Correspondence Graph”, makes it possible to observe in which position, or range of positions, the best correspondence between the images is found (FIG. 3).

In step (ii), the Correspondence Graph is applied for internal orthogonal search (FIG. 4) where the correspondence points are calculated for all the portions orthogonal to the main axis of the micro-CT image, acquired from the rock cylinder.

Thus, the region of maximum correspondence is identified. However, for this search to be complete, it is necessary to consider angular variations between the images, since they are not parallel to each other.

It is, therefore, necessary to search for the orthogonal cut, or depth in relation to the top, with the greatest number of co-registration points close to the main axis of the cylinder that originated the micro-CT image. This cut is related to the optimized depth for the multi-angle search, since the co-registration is associated with a plane that contains this central region of greatest correlation between the images.

Thus, in this second stage, the search for keypoints between the SEM and micro-CT images is restricted to the internal concentric region of the cylinder. To do this, a search radius is used that varies according to characteristics related to the granulometry, texture and mineralogical composition of the sample analyzed. Minimizing this internal search radius makes the peak associated with the co-registration increasingly representative of the best depth for the multi-angle search.

In stage (iii), the external multi-angle search (FIG. 5) is performed in a sub-volume of the external radius of the main axis of the cylinder. This procedure is applied based on the best correspondence plane obtained by internal orthogonal search.

Thus, this new search aims to obtain the best correspondence between keypoints of the edges of the SEM and micro-CT images. This is reflected in the identification of the best angular match of the SEM image (2D) with the micro-CT volume (3D). Since the quality of correspondences is measured by the number of matching points, isolating the region where the keypoints meet the edges throughout the multi-angle search results in the best correspondence.

This third stage is subdivided into two sequential phases, namely: gross multi-angle search and fine-tuning search. During the gross multi-angle search, comparisons of microtomography portions are tested in a series of equiangular azimuths varying every 10 degrees in the range of 0 to 360 degrees, with planar dives (dips) varying every 1 degree, being tested between 0 and 5 degrees.

These values can be adjusted according to the granulometric variation of the minerals, or according to the variation of the sample cutting plane. The variations used are adjusted for samples with granulometry ranging from 2 to 5 millimeters and the cutting plane of up to 5 degrees in relation to the orthogonal axis of the cylinder. In samples with particle sizes smaller than 2 millimeters, it is necessary to adjust the density of the gross multiangle search points, using variations of less than 1 degree. Regarding the dip plane, the search up to 5 degrees is valid for cuts established close to the perpendicular of this axis, more common in the oil and gas industry. The gross multiangle search, therefore, results in the gross azimuth and dip, which represent a peak associated with the general dip direction with the best correspondence, since the scan varied every 10 degrees. The fine-tuning search, however, consists of the density of the scan close to this direction with the greatest number of correspondences, aiming to find optimal azimuth and dip.

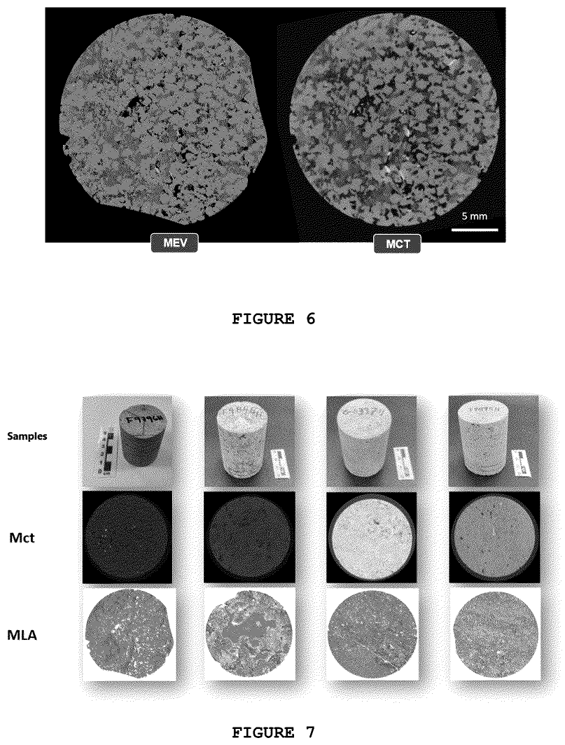

Thus, the search for the optimal azimuth was performed in equiangular intervals of 1 degree, with a 10-degree scan for the clockwise and counterclockwise directions, having as origin the direction found by the gross multiangle search. The variation for searching for the optimal dip occurs in the range of ±1 degree from the gross dip. The peak associated with the fine-tuning search is then interpreted as the best correspondence between the acquisitions, as can be seen in FIG. 6.

In a preferred embodiment, the total processing time for this search is approximately 2 to 4 hours on an AMD Ryzen 7 3750H computer (2.3 GHz-8 cores), on the Windows 11 Operating System, 128 GB PCIe NVMe SSD and 8 GB of DDR4 2666 MHz memory. The processing is done on the CPU and it is expected that the implementation of GPU processing can accelerate this search process by a few orders of magnitude.

### Example of Implementation

The co-registration process described was applied to 4 samples of carbonate reservoir plugs from the Pre-Salt. These samples were selected based on heterogeneity by visual inspection for consolidation, coloration and grain size.

This inspection allowed a comprehensive estimate of the heterogeneities of the physicochemical properties of the carbonate reservoirs. The samples were analyzed using 3D X-ray computed microtomography, as well as composition and mineralogical identification by automated SEM/EDS image analysis, as can be seen in FIG. 7.

The results of the co-registration, total processing time and the number of pairs of corresponding points found for these four samples are shown in Table 1. These results were obtained on an AMD Ryzen 7 3750H (2.3 GHz-8 cores) computer, under Windows 11 Operating System, 128 GB PCIe NVMe SSD and 8 GB of DDR4 2666 MHz memory:

TABLE 1
Processing time and co-registration
result for the four samples analyzed

| | Total | | |
|---|---|---|---|
| | Processing | | Correspondence |
| | Time | Co-registration | Points |
| Sample F9796H | 141 min | Cut 121 Az120 In2 | 649 |
| Sample G0397H | 174 min | Cut 75 Az262 In1 | 285 |
| Sample F9848H | 121 min | Cut 212 Az141 In1 | 190 |
| Sample F9895H | 184 min | Cut 232 Az181 In3 | 355 |

Cut: Depth of best correspondences after orthogonal search
Az: Azimuth of the dive direction of the best cut after external multiangle search
In: Dive intensity in the azimuth of the best cut after external multiangle search.

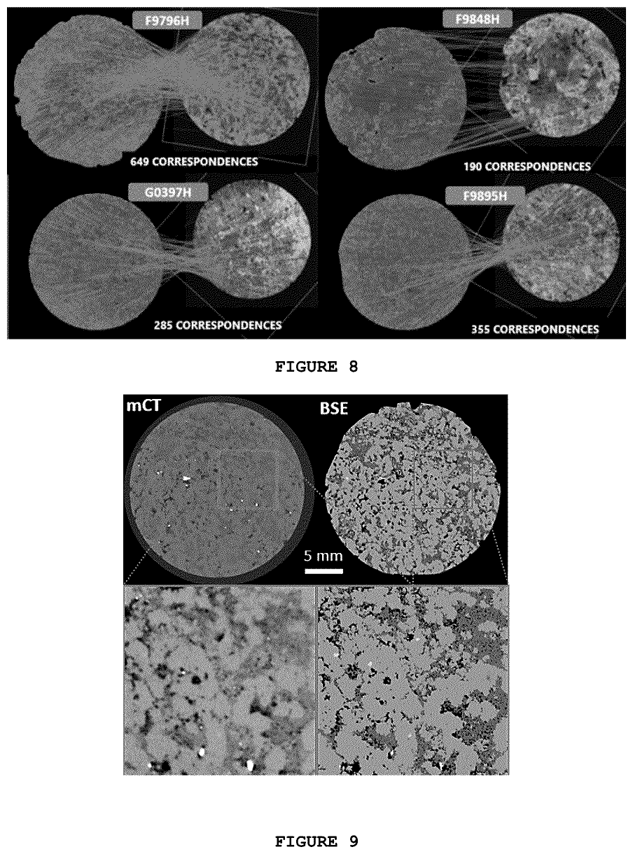

The connection between the best correspondence points of the SEM image and the best microtomography cut found by the algorithm being proposed can be seen in FIG. 8. The concentration of correspondence points is mainly associated with regions where the mineral contours are well-marked.

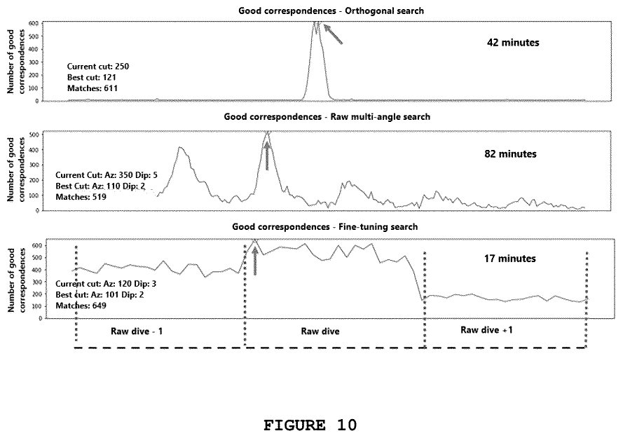

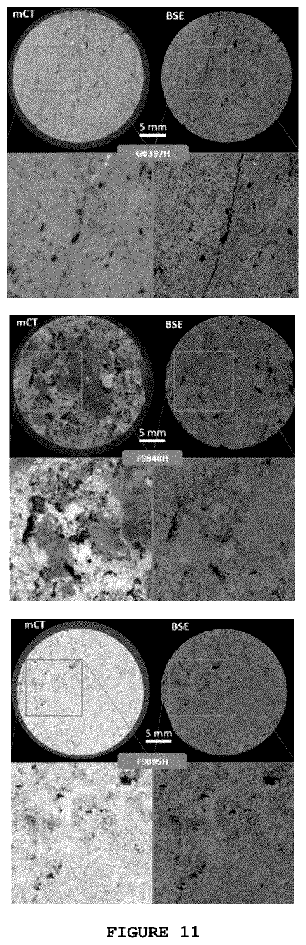

The co-registration for sample F9796 can be seen in FIGS. 8, as well as the best correspondence graphs for the internal orthogonal search and external multi-angle search phases, gross and fine-tuning, can be seen in FIG. 10.

In FIG. 5, the comparisons of the co-registration resulting from the automated search process are shown for the other 3 samples analyzed, indicating a high correspondence of attributes (pores, minerals, contacts, fractures). These results also show the versatility of the proposed method in relation to the textural, granular and mineralogical variability observed between the samples.

Thus, considering the results shown, it is clear that the present invention can automate the process of co-registration between SEM and micro-CT acquisitions, which was previously done visually. The result of the automated processing shows a high visual similarity and accuracy between the images and has become viable for application in deep learning algorithms for the purpose of predicting 3D mineralogy through microtomographic acquisition.

The advantage of this process is that a co-registration between the techniques can be obtained in approximately 2 to 3 hours after their acquisition. In addition, the process can be applied to existing databases, substantially reducing the need for the specialist to spend time on repetitive work.

In short, the technology being shown can be used as a standard procedure within the analytical protocol for image acquisition. This process has direct implications for the creation of digital rock models of the most varied types possible (Digital Rock), and for the creation of flow models in porous media, wettability analysis with controlled mineralogy, among others.

Furthermore, the invention directly implies the automated creation of labeled databases, since the interpreted SEM image can be used as the ground truth for deep learning algorithms based on convolutional processes.

The improvement of this technique and successive analytical tests can also be useful for co-registration in images composed of matrices of different natures, used in several applications. These applications can be related to geosciences, mineral and civil industries, or even in medical and clinical themes that require co-registration between SEM and tomography.

Those skilled in the art will value the knowledge being shown and will be able to reproduce the model in the modalities and in other variants, covered by the scope of the claims.

In some examples, the present disclosure may involve one or more of the following clauses:

Clause 1. An automatic tracking method for co-registration of two-dimensional (2D) Scanning Electron Microscopy (SEM) images and three-dimensional (3D) tomographic data of a rock cylinder, comprising the steps of:
(i) pre-processing one or more images acquired by SEM by reducing the spatial resolution and one or more images acquired by microtomography with the application of one or more image filters, followed by the application of a keypoint detection technique for comparison between the 2D SEM image and sequential sections of the microtomographic volume to create a correspondence graph;
(ii) internal orthogonal search from the correspondence graph created in step (i), where the correspondence points are calculated for all sections orthogonal to the main axis of the micro-computed tomography (micro-CT) image acquired from the rock cylinder;
(iii) external multi-angle search in a subvolume of the external radius of the main axis of the cylinder from the correspondence plane with the largest number of pairs of keypoints defined by comparing the images among those that make up the micro-CT volume (3D) pairwise with the SEM images (2D) and considered as inliers to the homography obtained by the internal orthogonal search.

Clause 2. The method according to clause 1, wherein the application of image filters is carried out by the sequence: Contrast Limited Adaptive Threshold (CLAHE), brightness, contrast, non local means.

Clause 3. The method according to clause 2, wherein a mask for low transmittance minerals that can generate artifacts in tomographic images, given the relative density contrast with the main mineralogical assembly, is applied to the SEM images to avoid the concentration of keypoints mainly in these minerals.

Clause 4. The method according to clause 1, wherein the pre-processed images are used as input for processing with the Oriented Fast and Rotated Brief (ORB) algorithm for keypoint detection.

Clause 5. The method according to clause 1, wherein binary vectors describing these keypoints are generated with the rotated Binary Robust Independent Elementary Features (rBRIEF) method.

Clause 6. The method according to clause 5, wherein the binary vectors of the SEM and tomographic images are compared using the Fast Library for Approximate Nearest Neighbors (FLANN) matcher method.

Clause 7. The method according to clause 1, wherein the correlations between keypoints found are filtered by means of the Lowe Ratio Test.

Clause 8. The method according to clause 1, wherein the pairs of keypoints considered as inliers to the homography are determined by the Random Sample Consensus (RANSAC) instruction set.

Clause 9. The method according to clause 1, wherein the correspondence graph is created with the training images (microtomography) on the abscissa axis and the points considered as inliers.

Clause 10. The method according to clause 1, wherein in step (ii), the search for keypoints among the SEM and micro-CT images is restricted to the internal concentric region of the cylinder. Clause 11. The method according to clause 10, wherein the search radius varies according to characteristics related to the granulometry, texture and mineralogical composition of the sample.

Clause 12. The method according to clause 1, wherein step (iii) is divided into two sequential phases called gross multi-angle search and fine-tuning search.

Clause 13. The method according to clause 12, wherein in the gross multi-angle search, comparisons of microtomography portions are tested in a series of equiangular azimuths varying every 10 degrees in the range of 0 to 360 degrees, and with planar dips varying every 1 degree, being tested between 0 to 5 degrees.

Clause 14. The method according to clause 12, wherein in the fine-tuning search, the direction with the greatest number of correspondences is investigated in equiangular intervals of 1 degree varying by 10 degrees for the clockwise and counterclockwise directions from the direction found by the gross multiangular search, and that the search for the optimal plunge plane occurs in the interval of ±1 degree from the gross plunge.

Clause 15. The method according to clause 1, wherein the keypoint is detected at the edges of one or more objects in the image.

1. An automatic tracking method for co-registration of two-dimensional (2D) Scanning Electron Microscopy (SEM) images and three-dimensional (3D) tomographic data of a rock cylinder, comprising the steps of:
(i) pre-processing one or more images acquired by SEM by reducing the spatial resolution and one or more images acquired by microtomography with the application of one or more image filters, followed by the application of a keypoint detection technique for comparison between the 2D SEM image and sequential sections of the microtomographic volume to create a correspondence graph;
(ii) internal orthogonal search from the correspondence graph created in step (i), where the correspondence points are calculated for all sections orthogonal to the main axis of the micro-computed tomography (micro-CT) image acquired from the rock cylinder;
(iii) external multi-angle search in a subvolume of the external radius of the main axis of the cylinder from the correspondence plane with the largest number of pairs of keypoints defined by comparing the images among those that make up the micro-CT volume (3D) pairwise with the SEM images (2D) and considered as inliers to the homography obtained by the internal orthogonal search.

2. The method according to claim 1, wherein the application of image filters is carried out by the sequence: Contrast Limited Adaptive Threshold (CLAHE), brightness, contrast, non local means.

3. The method according to claim 2, wherein a mask for low transmittance minerals that can generate artifacts in tomographic images, given the relative density contrast with the main mineralogical assembly, is applied to the SEM images to avoid the concentration of keypoints mainly in these minerals.

4. The method according to claim 1, wherein the pre-processed images are used as input for processing with the Oriented Fast and Rotated Brief (ORB) algorithm for keypoint detection.

5. The method according to claim 1, wherein binary vectors describing these keypoints are generated with the rotated Binary Robust Independent Elementary Features (rBRIEF) method.

6. The method according to claim 5, wherein the binary vectors of the SEM and tomographic images are compared using the Fast Library for Approximate Nearest Neighbors (FLANN) matcher method.

7. The method according to claim 1, wherein the correlations between keypoints found are filtered by means of the Lowe Ratio Test.

8. The method according to claim 1, wherein the pairs of keypoints considered as inliers to the homography are determined by the Random Sample Consensus (RANSAC) instruction set.

9. The method according to claim 1, wherein the correspondence graph is created with the training images (microtomography) on the abscissa axis and the points considered as inliers.

10. The method according to claim 1, wherein in step (ii), the search for keypoints among the SEM and micro-CT images is restricted to the internal concentric region of the cylinder.

11. The method according to claim 10, wherein the search radius varies according to characteristics related to the granulometry, texture and mineralogical composition of the sample.

12. The method according to claim 1, wherein step (iii) is divided into two sequential phases called gross multi-angle search and fine-tuning search.

13. The method according to claim 12, wherein in the gross multi-angle search, comparisons of microtomography portions are tested in a series of equiangular azimuths varying every 10 degrees in the range of 0 to 360 degrees, and with planar dips varying every 1 degree, being tested between 0 to 5 degrees.

14. The method according to claim 12, wherein in the fine-tuning search, the direction with the greatest number of correspondences is investigated in equiangular intervals of 1 degree varying by 10 degrees for the clockwise and counterclockwise directions from the direction found by the gross multiangular search, and that the search for the optimal plunge plane occurs in the interval of ±1 degree from the gross plunge.

15. The method according to claim 1, wherein the keypoint is detected at the edges of one or more objects in the image.
